(19) United States
(12) Patent Application Publication
(10) Pub. No.: US 2016/0114653 A1
(43) Pub. Date: Apr. 28, 2016

(54) System and Method for Controlling a Heating and Air Conditioning System in a Vehicle

(71) Applicant: Bayerische Motoren Werke Aktiengesellschaft, Muenchen (DE)

(72) Inventors: Oliver HORN, Muenchen (DE); Robert HERBOLZHEIMER, Groebenzell (DE)

(21) Appl. No.: 14/990,014

(22) Filed: Jan. 7, 2016

Related U.S. Application Data
(63) Continuation of application No. PCT/EP2014/064345, filed on Jul. 4, 2014.

(30) Foreign Application Priority Data
Jul. 8, 2013 (DE) 10 2013 213 347.2

(51) Int. Cl. B60H 1/32; B60H 1/22; B60H 1/00

(52) U.S. Cl. CPC B60H 1/3213; B60H 1/00764; B60H 1/00885; B60H 1/00907; B60H 1/22; B60H 2001/224

(57) ABSTRACT

A system and method are provided for controlling a heating and air-conditioning system, having a refrigerant circuit that can be operated as a heat pump system having an ambient heat exchanger in which, during cooling operation, heat is given up by the refrigerant to the air flowing through the ambient heat exchanger and, in heating operation, heat is picked up by the refrigerant from the air flowing through the ambient heat exchanger. A quantity of air flowing through the ambient heat exchanger is influenced by way of an electric fan. The electric fan is activated during cooling operation as a function of the refrigerant high-pressure and during heating operation as a function of a parameter independent of the refrigerant high pressure.

### CROSS REFERENCE TO RELATED APPLICATIONS

This application is a continuation of PCT International Application No. PCT/EP2014/064345, filed Jul. 4, 2014, which claims priority under 35 U.S.C. §119 from German Patent Application No. 10 2013 213 347.2, filed Jul. 8, 2013, the entire disclosures of which are herein expressly incorporated by reference.

### BACKGROUND AND SUMMARY OF THE INVENTION

The invention relates to a system and method for controlling a heating and air-conditioning system with a refrigerant circuit which can be operated as a heat pump system and has an ambient heat exchanger.

Basically, it is already known that in the cooling mode of heating and air-conditioning systems with a heat pump system, heat from the refrigerant is output to the air flowing through the ambient heat exchanger, and in the heating mode heat is taken up at the vaporizer in the air-conditioning device and at the ambient heat exchanger with a suitable refrigerant circuitry and is used for heating. Such a heating and air-conditioning system with a heat pump system is known, for example, from DE 102 53 357 B4.

Furthermore, it is known that in the conventional (cooling) operating mode of the refrigerant circuit in conventional vehicle air-conditioning systems, an electric fan is provided for metering the quantity of air which flows through the condenser. This electric fan is controlled in the cooling mode as a function of the refrigerant pressure, so that the outputting of heat from the refrigerant to the air flowing through the condenser can take place in a targeted fashion. In this context, the electric fan is actuated in such a way that the rotational speed of the electric fan is increased at a relatively high refrigerant pressure.

The object of the invention is to provide an operating strategy for the electric fan for metering the quantity of air flowing via the condenser or ambient heat exchanger to a heating and air-conditioning system with a refrigerant circuit which can be operated as a heat pump system and which is adapted to an optimum degree both to the cooling mode and to the heating mode.

This and other objects are achieved by a system and method according to embodiments of the invention. The system and method according to the invention and the corresponding control logic, as well as advantageous refinements thereof, can be implemented by way of an implemented algorithm or a corresponding assembly arrangement in at least one control unit provided for this purpose, in particular in a heating and air-conditioning control device.

The invention is based on the basic concept that the fan actuation, which is known in conventional vehicle air-conditioning systems, in the conventional operating mode of the refrigerant circuit constitutes a suitable actuation strategy only in the cooling mode, since in the heating mode in which the condenser or ambient heat exchanger, used as a vaporizer, in the heat pump is used, the refrigerant pressure does not constitute a measure for the necessary quantity of air via the ambient heat exchanger, i.e. the previous control of the electric fan as a function of the refrigerant pressure is unsuitable for the heating mode.

According to the invention, the electric fan is actuated as appropriately as possible in functional, energy and acoustic terms, in particular in such a way that for acoustic and energy reasons the rotational speed of the fan is set as low as possible taking into account the necessary quantity of air around the ambient heat exchanger.

Owing to the realization that in the heating mode of the heat pump system the refrigerant pressure does not constitute a suitable measure for the necessary quantity of air at the ambient heat exchanger, the system for controlling a heating and air-conditioning system is configured such that the electric fan by which the quantity of air flowing through the ambient heat exchanger is influenced is controlled in the cooling mode as a function of the refrigerant pressure, and in the heating mode as a function of a parameter which is independent of the high pressure of the refrigerant. The heating and air conditioning system has a refrigerant circuit which can be operated as a heat pump system and has an ambient heat exchanger, at which in the cooling mode heat from the refrigerant is output to the air flowing through the ambient heat exchanger, and in the heating mode heat from the air flowing through the ambient heat exchanger is taken up by the refrigerant.

Since in the heating mode the currently implemented heating power or the heating power which is to be implemented constitutes a relevant influencing factor on the necessary quantity of air flowing through the ambient heat exchanger, the electric fan is advantageously actuated in the heating mode as a function of a currently implemented heating power/heating power which is to be implemented. Since the implemented heating power or the heating power which is to be implemented depends in turn on the requested heating power and the external temperature, in the heating mode the electric fan can be controlled directly as a function of these two parameters which are easy to determine, i.e. the electric fan is advantageously actuated in the heating mode as a function of the requested heating power, the external temperature and/or the temperature of the air flowing through the ambient heat exchanger.

Specifically, the electric fan can be actuated as a function of these above-mentioned parameters in such a way that an actuation value or a basic rotational speed is determined as a function of a requested heating power and is subsequently raised or lowered by a factor as a function of the external temperature. The background to this is that at temperatures around 0° C. there is a particularly high risk of icing up of the ambient heat exchanger, and this risk can be reduced by increasing the rotational speed of the electric fan and therefore the quantity of air. The relationship between the requested heating power and the fan request or a necessary quantity of air is defined here in such a way that when a low heating power is requested the fan is actuated with a relatively lower rotational speed (and accordingly conveys a smaller quantity of air) than in the case of a higher requested heating power.

Additionally or alternatively, when suitable actuation of the electric fan in the heating mode is determined, the velocity of the vehicle is also taken into account, i.e. the electric fan can also be actuated in the heating mode as a function of the current velocity of the vehicle. In particular, the electric fan in the heating mode can be actuated as a function of the velocity and/or the actuation can be influenced in such a way that a fan request (rotational speed), determined on the basis of the requested heating power, of the electric fan is raised or reduced as a function of the velocity of the vehicle. In other words, by means of a (further) factor, the fan request can, for example, be lowered as a function of the velocity of the vehicle, since at high velocities—for example above 40 km/h—the air stream is sufficient to form a sufficient quantity of air via the ambient heat exchanger.

Likewise, it is additionally or alternatively possible also to take into account, in the determination of suitable actuation of the electric fan in the heating mode, the moisture of the external air and/or a determined dew point of the external air and/or the refrigerant temperature in the ambient heat exchanger, which is appropriately measured downstream of the ambient heat exchanger. The electric fan can advantageously be controlled, and a determined control variable influenced, in particular, as a function of the difference between the determined dew point and the refrigerant temperature downstream of the ambient heat exchanger.

Finally, it is also advantageously possible to provide that, in the heating mode, the electric fan is basically actuated with a minimum fan request or minimum rotational speed (for example 30%) irrespective of the at least one parameter to be evaluated.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a simplified block diagram illustrating control logic for an electric fan for metering a quantity of air, flowing via an ambient heat exchanger, of a refrigerant circuit in the form of a heat pump system of a heating and air-conditioning system in a motor vehicle.

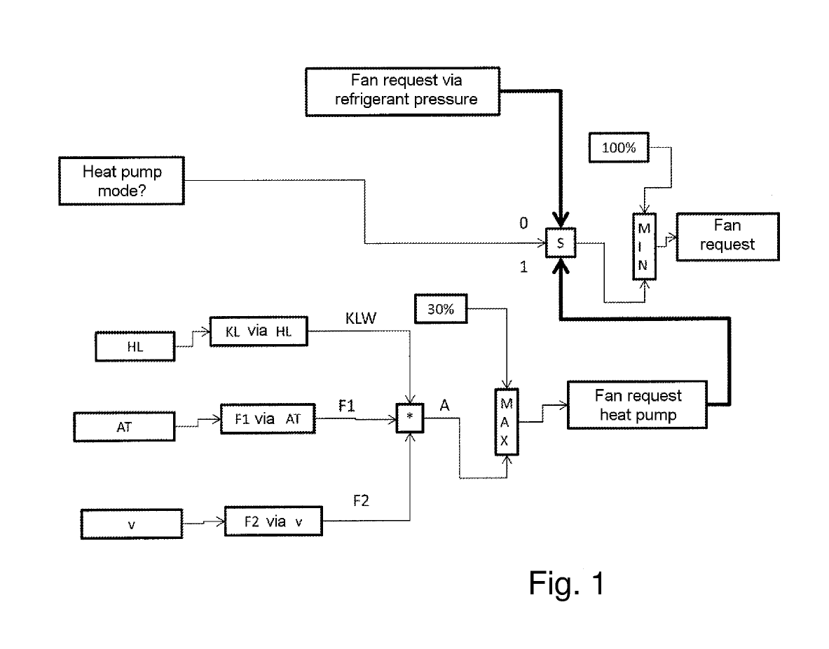

### DETAILED DESCRIPTION OF THE DRAWING

In detail, the control logic shows that with the actuation or the type of actuation of the electric fan a differentiation is basically made as to whether or not the refrigerant circuit is in the heat pumping mode. If the refrigerant circuit is not in the heat pumping mode, i.e. the air conditioning system is in the cooling mode, a centrally arranged switch S is moved to the position “0”, with the result that the electric fan is actuated as a function of the refrigerant pressure, i.e. “classic” air control by means of the refrigerant pressure is carried out.

However, if the heating air conditioning system is not in the cooling mode or so-called A/C mode but instead in the heat pump mode or heating mode in which heat is taken up at the vaporizer in the air conditioning device and at the ambient heat exchanger and used for heating, then the centrally arranged switch S is moved into the “1” position. The result is that the electric fan is not actuated as a function of the refrigerant pressure but rather as a function of a plurality of parameters independent of the refrigerant pressure—or the fan request is determined as a function of these parameters which are independent of the refrigerant pressure.

The determination of the fan request of the electric fan in the heating mode will now be explained in more detail below. Basically, in this example, a requested heating power HL, the external temperature AT and the vehicle velocity v are taken into account for this purpose.

First, a characteristic curve value KLW is determined for the fan actuation as a function of the requested heating power HL, wherein the relationship between the requested heating power HL and the characteristic curve value KLW for the fan control is defined by use of a characteristic curve KL stored in the control logic.

At the same time, a first factor F1 is determined as a function of the external temperature, and a second factor F2 is determined as a function of the vehicle velocity v. The above-mentioned characteristic curve value KLW (for example rotational speed of the fan) which is dependent on the requested heating power is subsequently multiplied by the determined first and second factors F1 and F2, as a result of which the characteristic curve value KLW is either increased or reduced. If, for example, the velocity of the vehicle is higher than 40 km/h, the second factor F2 can be less than 1 and can influence the characteristic curve value KLW in such a way that it is reduced, since owing to the velocity of the vehicle a sufficient quantity of air already flows through the ambient heat exchanger. If, for example, the external temperature is less than or approximately 0° C., in order to avoid icing up of the ambient heat exchanger, the first factor F1 can be given a value of greater than 1 and can therefore influence the characteristic curve value KLW in such a way that it is increased.

After the multiplication of the characteristic curve value KLW by the first and second factors F1 and F2, the corrected requested value A which results is compared in a unit MAX with a defined, lower minimum actuation request—in this example 30%—and the maximum of these two request values is output and transferred as the finally valid fan request to the actuation unit of the electric fan. Since the actuation value is specified in percentage terms in the example, this value can also be limited to the maximum appropriate value of 100%.

Therefore, by use of the system and method illustrated here, in particular by way of the corresponding actuation logic for the electric fan, it is possible to bring about an acoustically tolerable and energy efficient fan actuation of a correspondingly embodied heating and air conditioning system in a way which is compatible with requirements, with a refrigerant circuit which can be operated as a heat pump system both in the cooling mode and in the heating mode.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for controlling a heating and air-conditioning system having a refrigerant circuit operable as a heat pump system with an ambient heat exchanger, wherein in a cooling mode heat from the refrigerant is output to air flowing through the ambient heat exchanger and, in the heating mode, heat from the air flowing through the ambient heat exchanger is taken up by the refrigerant, the system comprising:
an electric fan configured to influence a quantity of the air flowing through the ambient heat exchanger;
control logic configured such that:
in the cooling mode, the electric fan is actuated as a function of high pressure of the refrigerant; and
in the heating mode, the electric fan is actuated as a function of a parameter that is independent of the high pressure of the refrigerant.

2. The system according to claim 1, wherein the electric fan is actuated in the heating mode as a function of currently implemented heating power.

3. The system according to claim 1, wherein the electric fan is actuated in the heating mode as a function of one or more of: (i) a requested heating power, (ii) a temperature of the air flowing through the ambient heat exchanger, and (iii) a current external temperature.

4. The system according to claim 2, wherein the electric fan is actuated in the heating mode as a function of one or more of: (i) a requested heating power, (ii) a temperature of the air flowing through the ambient heat exchanger, and (iii) a current external temperature.

5. The system according to claim 3, wherein the electric fan is actuated in the heating mode such that when a low heating power is requested, the electric fan is actuated with a relatively lower rotational speed than when a higher heating power is requested.

6. The system according to claim 5, wherein the electric fan is actuated in the heating mode such that a fan request, determined based on the requested heating power, of the electric fan is increased or reduced as a function of the current external temperature.

7. The system according to claim 3, wherein the electric fan is actuated in the heating mode such that a fan request, determined based on the requested heating power, of the electric fan is increased or reduced as a function of the current external temperature.

8. The system according to claim 1, wherein the electric fan is actuated in the heating mode as a function of a current vehicle velocity.

9. The system according to claim 8, wherein the electric fan is actuated in the heating mode such that a fan request, determined based on a requested heating power, of the electric fan is increased or reduced as a function of the current vehicle velocity.

10. The system according to claim 1, wherein the electric fan is actuated in the heating mode as a function of one or more of: (i) an external air moisture, (ii) a determined dew point of the external air, and (iii) a refrigerant temperature in or downstream of the ambient heat exchanger.

11. The system according to claim 10, wherein the electric fan is actuated in the heating mode as a function of a difference between the determined dew point of the external air and the refrigerant temperature in or downstream of the ambient heat exchanger.

12. The system according to claim 1, wherein the electric fan is actuated in the heating mode with a minimum fan request.

13. The system according to claim 1, wherein the electric fan is actuated with a maximum fan request.

14. A method for controlling a heating and air-conditioning system of a motor vehicle having a refrigerant circuit operable as a heat pump system with an ambient heat exchanger, the method comprising the acts of:
in a cooling mode of the heating and air-conditioning system, outputting heat from refrigerant in the refrigerant circuit to air flowing through the ambient heat exchanger;
in the heating mode of the heat and air-conditioning system, taking-up heat from the air flowing through the ambient heat exchanger by the refrigerant in the refrigerant circuit;
influencing a quantity of the air flowing through the ambient heat exchanger via an electric fan, wherein
the electric fan is actuated in the cooling mode as a function of high pressure of the refrigerant in the refrigerant circuit; and
the electric fan is actuated in the heating mode as a function of a parameter that is independent of the higher pressure of the refrigerant in the refrigerant circuit.

15. The method according to claim 14, wherein the actuating of the electric fan in the heating mode is carried out as a function of a currently implemented heating power.

16. The method according to claim 14, wherein the actuating of the electric fan in the heating mode is carried out as a function of one or more of: (i) a requested heating power, (ii) a temperature of the air flowing through the ambient heat exchanger, and (iii) a current external temperature.

17. The method according to claim 16, wherein the actuation of the electric fan in the heating mode is carried out such that when a low heating power is request the fan is actuated with a relatively lower rotational speed than when a higher heating power is requested.

18. The method according to claim 17, wherein the actuating of the electric fan in the heating mode is carried out such that a fan request, determined based on the requested heating power, of the electric fan is increased or reduced as a function of the current external temperature.

19. The method according to claim 14, wherein the actuation of the electric fan in the heating mode is carried out as a function of a current vehicle velocity.

20. The method according to claim 19, wherein the actuation of the electric fan in the heating mode is carried out such that a fan request, determined based on the requested heating power, of the electric fan is increased or reduced as a function of the current vehicle velocity.
